(19) United States
(12) Patent Application Publication
(10) Pub. No.: US 2012/0198641 A1
(43) Pub. Date: Aug. 9, 2012

(54) Hygiene Pad, Dental Care System Employing Same, and Method of Using Same

(75) Inventor: Brigitte Lehnert, Palm Springs, CA (US)

(73) Assignee: Walking Sticks Production Inc., Palm Springs, CA (US)

(21) Appl. No.: 13/021,139

(22) Filed: Feb. 4, 2011

(51) Int. Cl. A46B 15/00; B32B 3/02

(52) U.S. Cl. 15/106; 428/411.1; 428/66.7

(57) ABSTRACT

A dental care system has a base, an oral hygiene instrument removably couplable to the base, and a hygiene pad. The hygiene pad has a top layer formed of a liquid absorbing material, a bottom layer configured to contact a surface on or adjacent the dental care system, and an inner layer adhered between the top and the bottom layers and containing a disinfectant. The hygiene pad is positionable and shaped so as to collect and absorb liquid residue dripping from an oral hygiene instrument.

### 1. FIELD OF THE DISCLOSURE

The present disclosure is generally directed to dental care instruments, and more particularly, to a hygiene pad for use with dental care instruments and systems to prevent the accumulation of liquid residue on the components of same.

### 2. BACKGROUND OF THE INVENTION

Oral hygiene instruments such as electric and manual toothbrushes, oral irrigators, and waterpiks are well known. Such instruments are used to improve and maintain dental hygiene. These instruments are often placed and stored in an upright position on a base, such as a stand, holder tree, or tumbler, for recharging and/or storage when not in use. However, after an instrument is used, water, saliva, and/or toothpaste residue often adheres to some part—the handle, the head, or the bristles—of the instrument. This residue eventually drips or runs down the head and the handle, only to find its way onto the bottom or side surfaces of the base or the support surface underneath the base.

If left untouched, the residue will accumulate on one or more of these surfaces. After several days, the residue, which often contains plaque and germs from a user's mouth, forms an ugly and unhygienic calcium carbonate deposit on the base, on the lower parts of the instruments, and/or the support surface underneath the base. Because of the wet environment, these deposits facilitate abundant germ growth. The result is a dental care system that may be very unhygienic and requires frequent, diligent cleaning to preserve hygiene.

### BRIEF DESCRIPTION OF THE DRAWINGS

Objects, features, and advantages of the present invention will become apparent upon reading the following description in conjunction with the drawing figures, in which:

FIG. 1 is a perspective view of one example of a generic dental care system employing two different instrument examples, each according to the teachings of the present invention.

FIG. 2 shows a cross-section taken along the center of the larger diameter hygiene pad shown in FIG. 1.

FIG. 3 shows a cross-section view taken along line 3-3 in FIG. 1 of the dental care instruments stored in the base of the system.

FIG. 4 is a perspective exploded view of another example of a dental care system in accordance with the teachings of the present invention.

FIG. 5 is a cross-section view taken along line 5-5 in FIG. 4 of the dental care system when in use.

FIG. 6 is a cross-section view of the dental care system of FIG. 5 but including an alternate example of a hygiene pad in accordance with the teachings of the present invention.

FIG. 7 is a cross-section view of the dental care system of FIG. 5 but including yet another alternate example of a hygiene pad in accordance with the teachings of the present invention.

FIG. 8 is a plan view of another example of a hygiene pad in accordance with the teachings of the present invention.

FIG. 9 is a cross-section view of the hygiene pad of FIG. 8 in use within another example of a dental care system in accordance with the teachings of the present invention.

FIG. 10 is a plan view of another example of a hygiene pad in accordance with the teachings of the present invention.

FIG. 11 is a side or edge view of another example of a hygiene pad in accordance with the teachings of the present invention.

FIG. 12 is a cross-section view of another example of a hygiene pad in accordance with the teachings of the present invention.

FIG. 13 is a plan view of another example of a hygiene pad in accordance with the teachings of the present invention.

FIG. 14 is a cross-section view of the dental care system of FIG. 5 but including the hygiene pad of FIG. 13 in use.

FIG. 15 is a partial cross-section view of another example of a dental care system in accordance with the teachings of the present invention.

### DETAILED DESCRIPTION OF THE DISCLOSURE

In one example, the present invention provides a hygiene pad for use with dental care systems in order to prevent the formation or build-up of calcium carbonate deposits on components and instruments of the system. The pad can inhibit abundant germ growth and also reduce the frequency and diligence necessary to maintain hygiene of the system.

The present invention is generally directed to a dental care system comprising a base, an oral hygiene instrument removably coupled to the base and a hygienic pad formed of a material capable of absorbing liquid residue. The hygiene pad can be positioned on, adjacent, or under part of the base and serves to (i) collect or absorb residue dripping from or along the oral hygiene instrument when the oral hygiene instrument is coupled to the base; and (ii) accelerate evaporation of water residue from the dental care system to prevent the residue from accumulating thereon. The hygiene pad thus can prevent or reduce germ growth and deposit build-up, but can also eliminate the need for frequent cleaning of parts of the dental care system.

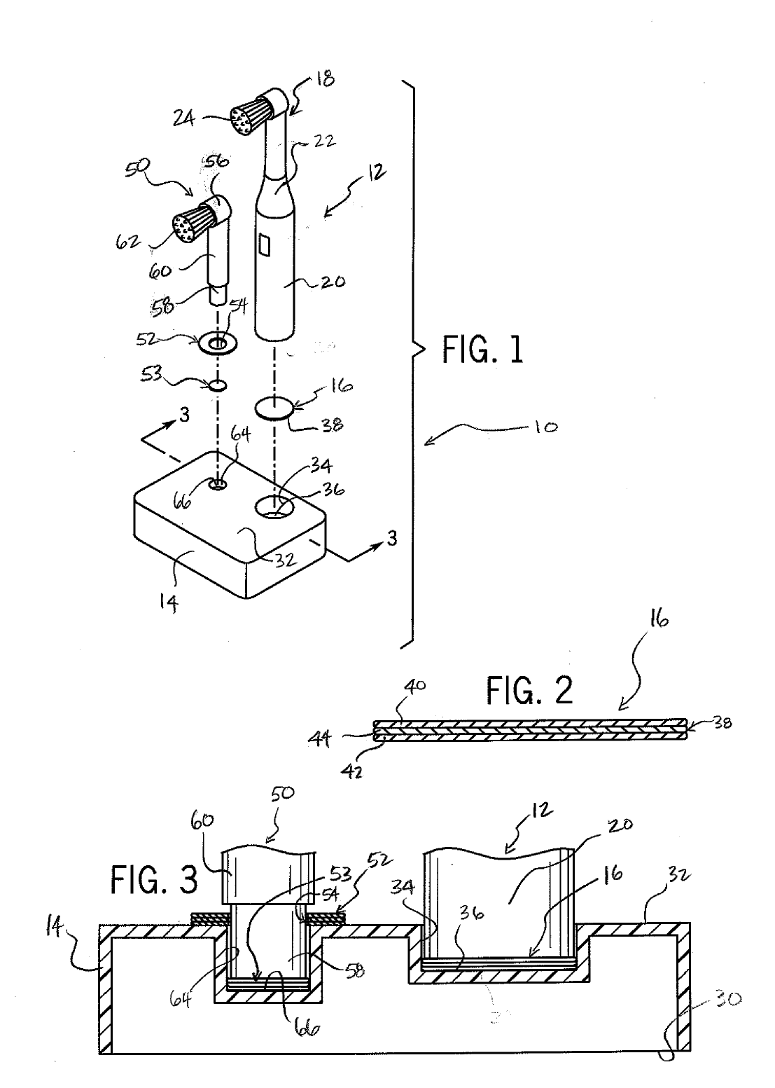

FIG. 1 shows a generic example of a dental care system 10 in accordance with the teachings of the present invention. In this example, the dental care system 10 has two different oral hygiene instruments and one base and employs three different examples of hygiene pads.

One oral hygiene instrument is an electric toothbrush or oral irrigator 12. The base in system 10 is in the form of a rectangular or polygonal stand or recharge housing 14. The system 10 also employs one example of a hygiene pad 16 for use with the instrument 12. The pad 16 is a circular hygiene pad disposed between or adjacent to the toothbrush 12 and the stand 14, as described below. As is known in the art, the instrument 12 or toothbrush can generally include a skinny cap 18, a wide shaft or handle 20, and a tapering neck 22 that connects the handle with the head. The cap 18 includes a set of outwardly extending bristles 24 that are primarily configured to clean a user's teeth and/or gums.

In this example, the recharge housing 14 has a rectangular profile. In other examples, the recharge housing 14 may also have a circular, square, domed, or irregular profile and still function as a base for the oral hygiene instrument. As shown in FIG. 1, the recharge housing 14 has an exposed exterior surface 32 and a hidden underside surface 30 that rests on a support surface such as a countertop, table, or the floor. The recharge housing 14 further includes a first circular receptacle 34 recessed into the exterior surface 32, with a closed bottom surface 36 at a bottom of the receptacle. The size of the receptacle 34 may vary depending on the size of the handle 20 of the toothbrush or instrument 12.

FIG. 2 provides a more detailed illustration of the pad 16 shown in FIG. 1 for the receptacle 34 and instrument 12 and utilized with the dental care system 10. In this example, the circular pad 16 has a perimeter or circumferential edge 38 that surrounds the body of the pad. The pad 16 in this example is a multi-layered pad with a top layer 40, a bottom layer 42, and an inner layer 44 sandwiched and adhered between the top and bottom layers. The top layer 40 can be formed of a liquid absorbing material such as paper, cellulose, or the like. The bottom layer 42 can be configured to contact a surface on or adjacent the dental care system. The bottom layer 42 can be of the same material as the top layer 40, or can be made of a different material.

The pad 16 may also be comprised of more or less layers than described. For example, the pad 16 may have a top layer, a bottom layer, and multiple inner layers adhered between the top and the bottom layers, and still fall within the scope and spirit of the present invention. Likewise, the pad 16 may only have a bottom and a top layer, or even just one absorbent layer. As shown in FIG. 2, the top, bottom, and inner layers 40, 42, and 44 are adhered or otherwise attached together both along the body of the pad 16 and adjacent the perimeter edge 38 of the pad. In other examples, the top, bottom, and inner layers may be adhered together differently, e.g., the top, bottom, and inner layers may be adhered together along certain points of the diameter of the pad, but not adhered together at other points along the diameter of the pad. In this example, the top, bottom, and inner layers are adhered together by locally pressing the top and bottom layers together with significant pressure or compression force. In other examples, the layers can be adhered together via glue, laminate, rubber cement, heat, or the like.

FIG. 3 shows the pad 16 in an in-use position in the dental care system 10. In this example, the pad 16 can be positioned on the recharge housing 14 along the bottom surface 36 within the receptacle 34. When the toothbrush 12 is inserted into the receptacle 34, the pad 16 is located between the handle 20 of the toothbrush 12 and the stand 14 so as to collect, absorb, and evaporate the liquid residue that drips or falls from or on the toothbrush 12.

With reference again to FIG. 1, the dental care system 10 also includes another oral hygiene instrument, a brush head 50 removed from a toothbrush handle or shaft (not shown), also used in connection with the stand 14. The system 10 employs both two examples of hygiene pads 52 and 53 for use with the brush head 50. The pad 52 is an annular ring with an open center 54 and is disposed around the brush head 50 on the stand 14, as described below. The pad 53 is smaller than, but identical in all other respects to, the pad 16 previously described. The pad 53 is disposed between or adjacent to the toothbrush 50 and the stand 14, as described above.

As is generally known in the art, the brush head 50 generally includes a cap 56, a collar 58, and a neck 60 that connects the head with the collar. As shown in FIG. 1, the brush head 50 includes a plurality of bristles 62 outwardly extending from the cap 56, and the collar 58 has a narrower diameter than the neck 60. The stand 14 has a receptacle 64 that is similar to, but smaller than, the receptacle 34 previously described. Like the receptacle 34, the receptacle 64 is recessed into the exterior surface 32 of the stand 14 and has a closed bottom surface 66.

As shown in FIG. 3, the pad 53 is received in the receptacle 64 and positioned along the bottom surface 66 therein. The pad 52 is positioned on the exterior surface 32 of the stand 14 such that the pad 52 surrounds the receptacle 64. More specifically, the annular ring of the pad 52 surrounds a perimeter or circumferential edge of the receptacle 64 while the open center 54 of the pad aligns concentrically with the opening formed by the receptacle.

FIG. 3 shows the brush head 50 after it has been used, detached from the toothbrush handle, and then coupled to the stand 14. More particularly, the collar 58 is inserted through the open center 54 of the pad 52 and seated against the bottom surface 66 in the receptacle 64 so that it contacts the pad 53. Accordingly, the annular ring of the pad 52 surrounds the collar 58 on the exterior surface 32 of the stand. Together, the pads 52 and 53 prevent the accumulation of residue on the dental care system 10 by collecting, absorbing, and encouraging evaporation of liquid that drips from the brush 50. Alternatively, the dental care system 10 need not include both pads 52 and 53. Instead, the dental care system 10 may employ one of the pads and still perform as intended.

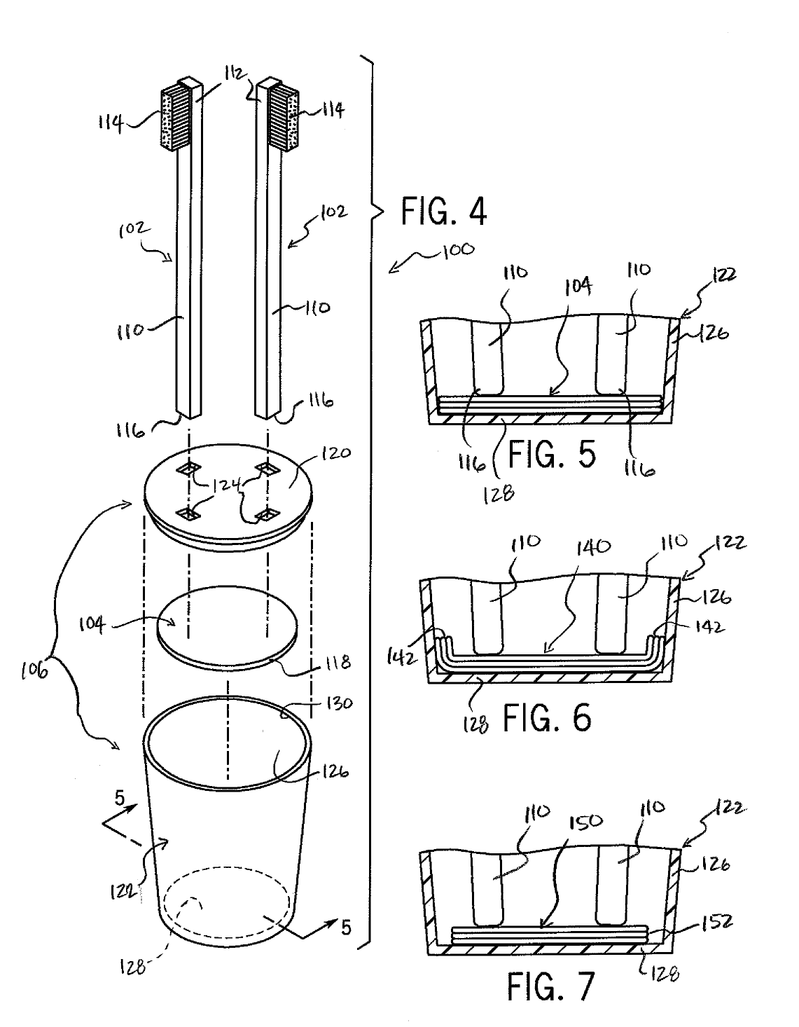

FIG. 4 shows another example of a dental care system 100 in accordance with the teachings of the present invention. In the dental care system 100, the oral hygiene instrument is a manual or standard toothbrush 102, the pad is a circular hygiene pad 104, and the base is a tumbler 106. As is known in the art, the standard toothbrush 102 generally includes a handle 110, a cap 112, and a plurality of bristles 114 extending from the cap. The vertically elongate handle 110 terminates at a distal end 116. The pad 104 in this example is similar in shape to the pad 16 described above in connection with FIGS. 1-3, but is sized to have a larger diameter approximately equal to the diameter within the interior of the tumbler 106. The pad 104 includes a perimeter or circumferential edge 118.

In this example, the tumbler 106 includes a tumbler lid 120 and a tumbler base 122. As is known in the art, the tumbler lid 120 has a generally circular shape sized to fit and close an open top of the tumbler, and includes a number of toothbrush receiving openings 124. The tumbler base 122 has a generally vertical or upstanding sidewall 126 and a closed bottom surface 128 coupled to the sidewall and designed to hold and support the contents of the tumbler 106. When the dental care system 100 is in use, the tumbler lid 120 is attached to the tumbler base 122 by placing the lid onto a top perimeter edge 130 of the sidewall 126. In other examples, the tumbler lid 120 and the tumbler bottom 122 may be integrally formed so that the tumbler 106 is one piece with no removable lid.

In FIG. 5, the pad 104 is placed in the interior of the tumbler base 122 and positioned against the surface of the closed bottom 128. In this example, the circumferential edge 118 of the pad 104 engages or abuts an interior of the sidewall 128. The tumbler lid 120 may then be attached to the tumbler base 122 as noted above. When the standard toothbrush 102 is inserted into the openings 124, the handle 110 drops into the tumbler base 122 until the distal end 116 of the toothbrush 102 abuts the pad 104. At this point, the pad 104 is configured to collect, absorb, and evaporate liquid residue that drips from the toothbrush 102.

FIG. 6 shows an alternative hygiene pad 140 inserted into the tumbler 106 instead of the pad 104. In this example, the pad 140 has a circumferential or perimeter edge 142. As shown, the pad 140 has a larger diameter than the diameter of the closed bottom 128 of the tumbler base 122. Specifically, the circumferential edge 142 extends upwards along a portion of the sidewall 126 within the tumbler base 122. The pad 140 has a larger surface area than the pad 104 shown in FIG. 5, which can increase the ability of the pad 140 to absorb liquid residue and can further facilitate evaporation of water within the dental care system 100.

FIG. 7 shows another alternate pad 150 replacing the pads shown in FIGS. 5 and 6. In this example, the pad 150 has a circumferential or perimeter edge 152. As shown, the pad 150 has a smaller diameter than the closed bottom 128 of the tumbler base 122. More particularly, when the pad 150 is positioned on the closed bottom 128, there is a gap between the edge 152 and the sidewall 126 of the tumbler base 122. This gap may increase air circulation along the perimeter edge 152 within the tumbler base 122, which, in turn, may encourage faster evaporation of the water residue absorbed by the pad 150.

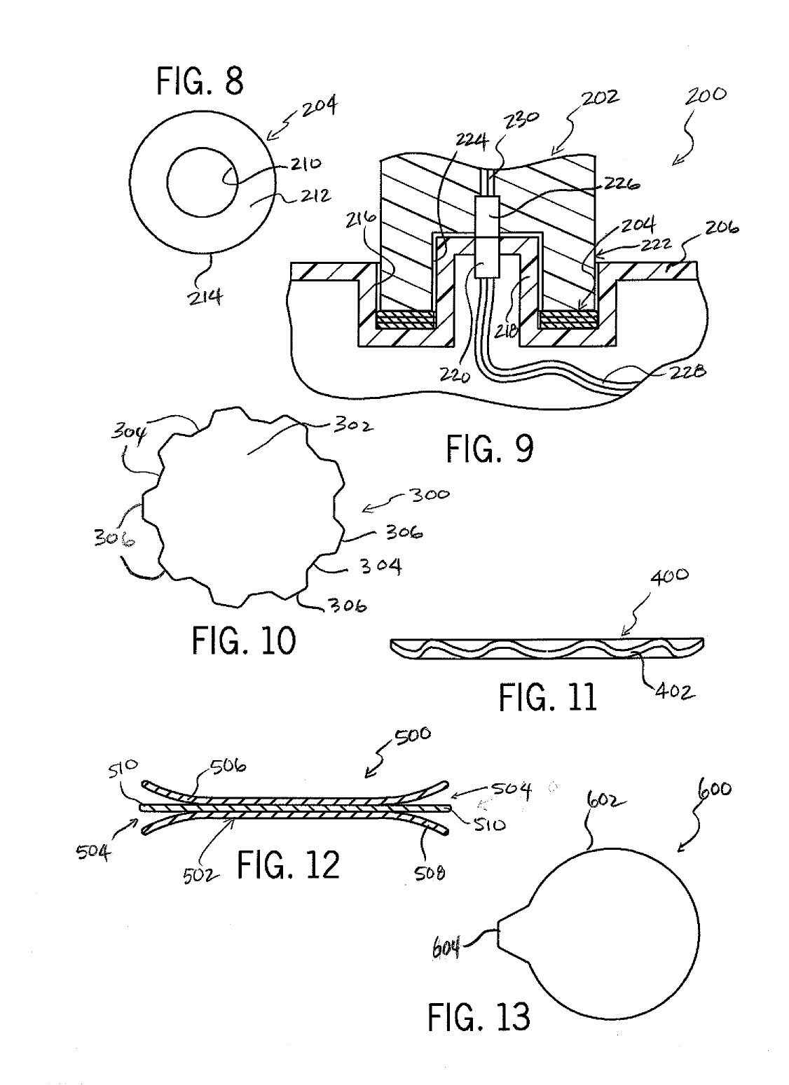

Each of FIGS. 8-13 illustrates an alternative pad embodiment that may be used in connection with the dental care systems 10, 100, or any other dental care system covered but not specifically described herein.

FIG. 8 shows an annular hygiene pad 204 with a central opening 210, an annular body 212, and a perimeter or circumferential edge 214. The body 212 is bounded on the inside by the center opening 210 and on an outside by the perimeter edge 214.

FIG. 9 shows a dental care system 200 in accordance with the teachings of the present invention that utilizes the annular pad 204 shown in FIG. 8. In the dental care system 200, the oral hygiene instrument is an electric appliance 202 such as a toothbrush or oral irrigator similar to the electric toothbrush or oral irrigator 12 described in connection with the dental care system 10. The base is a stand 206 that simultaneously serves as both a support and a charger for the appliance 202. In this example, the stand 206 has an aperture 216 and an upwardly projecting post 218 central to the aperture 216. As shown in FIG. 9, the upwardly projecting post contains wire leads 228 embedded therein. The wire leads 228 terminate at an electrical contact 220 provided on a top of the upwardly projecting post 218 as shown in FIG. 9. In this example, the free or distal end of the appliance 202 has a female connector 222 with a central orifice 224 configured to receive the post therein when seated in the receptacle 216 of the stand 206. As shown in FIG. 9, the female connector 222 contains wire leads 230 embedded therein. The wire leads 230 terminate at an electrical contact 226 for contacting or electrically engaging the contact 220 for charging the appliance 202.

As is shown in FIG. 9, the pad 204 is configured to be positioned on the charger 206. When the pad 204 is installed on the stand 206, the upwardly projecting post 218 extends through the center opening 210 of the pad. The body 212 of the pad then sits at the bottom of the receptacle 216. When the appliance 202 is coupled to the stand 206, the end of the connector 222 engages or abuts the body 212 of the pad 204 while the orifice 224 receives the post 218 therein. This coupling allows the electrical contacts 222, 226, on the stand 206 and the appliance 202, respectively, to make electrical contact in order to charge the appliance 202 while it is seated on the stand 206. In other examples, the appliance 202, the pad 204, and/or the stand 206 may be sized or shaped differently. Likewise, the receptacle 216 and mating connector 222 and/or the contacts 222, 226, may vary and yet still permit the electrical contacts 222, 226, to join together and charge the toothbrush 202 on the stand 206.

FIG. 10 shows another example of a hygiene pad 300 in accordance with the teachings of the present invention. In this example, the hygiene pad 300 has a body 302 with a circumferential or perimeter edge 304 and a plurality of radially projecting tabs 306 that extend outward from and are spaced apart around the perimeter edge 304. The tabs 306, which in this example are shaped like a trapezoid, serve to increase the surface area of the pad 300 and the length of the circumferential or perimeter edge. The increased surface area improves the pad's ability to absorb and/or evaporate residue that drips from an oral hygiene instrument. The increased length of the circumferential or perimeter edge also improves the pad's ability to evaporate liquid. In other examples, the pad 300 may have tabs of a different number, spacing, shape or size. For example, the tabs may have a square or triangular shape and still function as intended. Likewise, the pad 300 may, in other examples, have a fewer or greater number of tabs as desired.

FIG. 11 shows another example of a hygiene pad 400 in accordance with the teachings of the present invention. In this example, the pad 400 has an undulating or serpentine rim 402 when viewed on edge. This edge or rim feature increases the surface area or material quantity of the pad 400, which in turn increases the capability of the pad 400 to absorb or evaporate liquid residue. In other examples, the non-flat rim may have a different peak or wavelength frequency to increase or decrease the surface area of the hygiene pad, as desired. The curved serpentine shape could also be replaced by a rim with sharp pleats for greater surface area.

FIG. 12 shows yet another example of a hygiene pad 500 in accordance with the teachings of the present invention. In this example, the pad 500 has a body 502 with a perimeter edge 504. The pad 500 also comprises a top layer 506, a bottom layer 508, and an inner layer 510 adhered between the top and bottom layers 506, 508. As is shown in FIG. 12, the top, bottom, and inner layers 506, 508, and 510 are adhered together over a majority of the body diameter. The edges of the layers near the perimeter edge 504 are not adhered together. This frayed configuration exposes more pad material by allowing the edges to spread along the perimeter edge 504, This can increase the surface area of the pad 500 and can leave the edges uncompressed. This structure can increase the pad's ability to absorb and evaporate liquid residue. The effect of this frayed configuration may be magnified by including more than one inner layer between the top and the bottom layers. In other examples, the pad may have a top, bottom, and two or more inner layers, such as 4-6 inner layers. Such a design exposes even more pad material by spreading the multiple layers along the perimeter edge 504, resulting in an even greater exposed surface area of the pad 500 and increasing the pad's ability to absorb and evaporate liquid residue.

FIG. 13 shows yet another example of a hygiene pad 600 in accordance with the teachings of the present invention. In this example, the pad 600 is a generally circular disc with a circumferential or perimeter edge 602. The pad 600 also has a tab 604 that extends radially outward from the perimeter edge 602. The tab 604 in this example is primarily configured to facilitate insertion or removal of the pad 600 from a device in a dental care system. The tab 604 in this example is relatively large and has a trapezoidal shape so as to be easy to grasp. In other examples, the pad 600 may be sized or shaped differently and/or may have a different size or shaped tab.

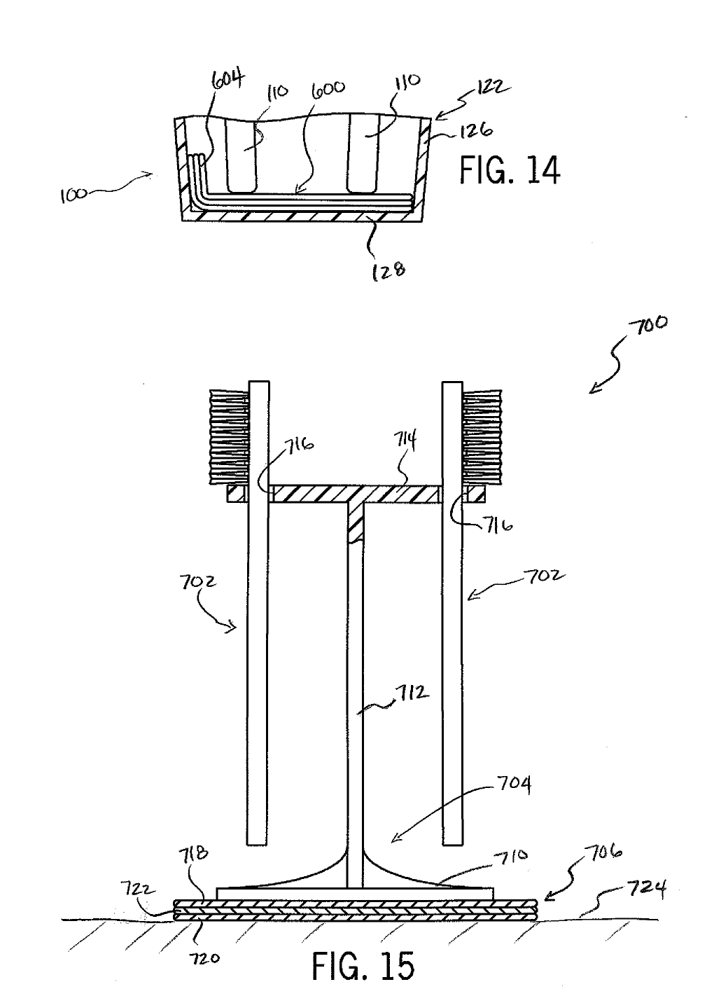

FIG. 14 shows the pad 600 used in connection with the dental care system 100. In this example, the pad 600 is placed into the tumbler base 122 and positioned along the closed bottom 128. As shown, the tab 604 extends upward along the sidewall 126 of the tumbler base 122. This allows a user to grab or grasp the tab 604 in order to easily remove the pad 600 from the tumbler base 122 for cleaning, drying, or disposal of the pad. Though not specifically shown, the pad 600 may also be used with other dental care systems disclosed herein, or with a dental care system not specifically disclosed herein but nonetheless covered by this disclosure.

FIG. 15 illustrates yet another dental care system 700 in accordance with the teachings of the present invention. In the dental care system 700, the oral hygiene instrument is a standard, manual toothbrush 702, the base is an upright tree-type stand 704 and the pad is a hygiene pad 706. The toothbrush 702 is essentially identical to the toothbrush 102 previously described. In this example, the tree stand 704 has a pedestal 710 that supports an upwardly projecting trunk 712. A holder 714 is supported at a top end of the trunk 712. One or more apertures or receptacles 716 can be formed in the holder 714 to hold one or more toothbrushes 702.

In this example, the pad 706 is larger than the pedestal 710 of the stand 704. Much like other pads previously described, the pad 706 in this example has a top layer 718, a bottom layer 720, and an inner layer 722 adhered between the top and bottom layers. Here, however, the top layer 718 can be formed of a liquid absorbing material and configured to contact the pedestal 710. The bottom layer 720 can be configured to engage a support surface 724, such as a countertop or a shelf, upon which the dental care system 700 may rest. The bottom layer 720 can also have friction enhancing or anti-slip properties or be formed of a friction enhancing material.

As shown in FIG. 15, the pad 706 can be placed onto the support surface 724. The stand 704 and, more particularly, the pedestal 710 is then placed onto the pad 706. When a user has finished using the toothbrush 702, the toothbrush 702 may be inserted through the aperture 716 in the holder 714 and suspended by the stand 704 as shown. Any water or other residue that drips from the toothbrush 702 will be absorbed by the pad 706. This can keep the support surface 724 clean and prevent accumulation or build-up of water or other residue on the support surface 724. The pad 706 also serves to stimulate evaporation of water or any other residue that may drip from the pedestal 710 or any other part of the stand 704 onto the pad 706.

The hygiene pads described in the above examples can be made from a biodegradable material and can thus be environmentally friendly. It is preferable that the pads also have a thickness of less than 3 mm, making them a small and convenient solution to the problems associated with dental care systems. In other examples, however, the pads may have a thickness of greater than 3 mm, if it is desirable to have a thicker, more durable pad for absorbing larger quantities of liquid residue. It is also preferable that the pads be manufactured from a suitable absorbent material, such as paper, cellulose, woven fabric, fiber, a synthetic, or the like.

The hygiene pads described in the above examples can be formed of or enhanced to provide one of the dental care systems described herein with anti-bacterial properties. For example, one or more layers of the pads can be sprayed, embedded, or impregnated with a disinfectant or an anti-bacterial/anti-microbial substance, such as a salt, bleach, hydrogen peroxide, or the like, to help kill germs and inhibit germ growth in the pad and, more generally, the dental care system. Alternatively, one or more layers of the pads can be sprayed, embedded, or impregnated with a deodorant or perfume to provide the pads and the dental care system with a pleasurable scent.

The hygiene pads described in each of these above examples are also advantageous because they can be replaced quickly and easily. When the pad becomes excessively wet or dirty, a user can simply remove the pad from the base or other surface, dispose of the pad, and position a new pad on the surface or base as desired. Given the relatively low cost of these pads, this may be done once every few days or at the very least, once a week.

Although certain dental care systems, oral hygiene instruments, bases, and hygiene pads been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A pad for use with a dental care system, the pad comprising:
a top layer formed of a liquid absorbing material;
a bottom layer configured to contact a surface on or adjacent the dental care system;
at least one inner layer adhered between the top and the bottom layers and containing a disinfectant;
wherein the pad is positionable and shaped so as to collect and absorb liquid residue dripping from an oral hygiene instrument.

2. The pad of claim 1, wherein the top, bottom, and inner layers are adhered together at an interior of the pad but are not adhered together adjacent a perimeter edge of the pad.

3. The pad of claim 1, further comprising a tab that extends radially outward from a perimeter edge to facilitate insertion or removal of the pad.

4. The pad of claim 1, wherein the pad has a circumferential edge and a plurality of radially projecting tabs that extend outwardly from the circumferential edge.

5. A dental care system comprising:
a base;
an oral hygiene instrument removably couplable to the base;
a hygiene pad formed of a material capable of absorbing liquid residue,
wherein the hygiene pad is positioned on the base to collect liquid residue dripping from the oral hygiene instrument when the oral hygiene instrument is coupled to the base.

6. The dental care system of claim 5, wherein the oral hygiene instrument is electric and the base is a stand with a receptacle configured to receive a handle end of the oral hygiene instrument therein.

7. The dental care system of claim 6, wherein the hygiene pad is received within a bottom of the receptacle.

8. The dental care system of claim 6, wherein the hygiene pad surrounds an opening to the receptacle.

9. The dental care system of claim 6, wherein the hygiene pad is an annular ring with a center opening to permit an electrical contact of the oral hygiene instrument to electrically connect with a corresponding contact within the receptacle.

10. The dental care system of claim 5, wherein the oral hygiene instrument is a manual toothbrush and the base is a tumbler with a tumbler lid having multiple tooth brush receiving openings, and wherein the pad is positioned in an interior of the tumbler against a closed bottom thereof.

11. The dental care system of claim 10, wherein the hygiene pad is a disc having a radially projecting tab configured to facilitate insertion or removal of the hygiene pad from the interior of the tumbler.

12. The dental care system of claim 5, wherein the hygiene pad is a disc having a radially projecting tab configured to facilitate insertion or removal of the hygiene pad from the base.

13. The dental care system of claim 5, wherein the hygiene pad is larger than the base and is located between the base and a support surface upon which the base rests.

14. The dental care system of claim 5, wherein the hygiene pad includes a disinfectant.

15. The dental care system of claim 5, wherein the hygiene pad has a top layer, a bottom layer, and an inner layer adhered between the top and the bottom layers.

16. The dental care system of claim 15, wherein the inner layer has anti-bacterial properties.

17. A method for preventing residue from accumulating on parts of a dental care system, the method comprising the steps of:
providing a dental care system with a base and an oral hygiene instrument removably couplable to the base;
positioning a pad formed of an absorbent material on a surface of or adjacent the base beneath or in contact with the oral hygiene instrument when coupled to the base;
removing the oral hygiene instrument from the base for use;
returning the oral hygiene instrument to the base following use whereby liquid residue dripping from the oral hygiene instrument is absorbed by the pad; and
replacing the pad periodically with a new pad after multiple uses of the oral hygiene instrument.

18. The method of claim 17, wherein the step of positioning comprises the step of positioning the pad on an enclosed bottom in a receptacle of the base.

19. The method of claim 17, wherein the step of positioning comprises the step of positioning the pad under the base.

20. The method of claim 17, wherein the step of positioning comprises the step of positioning the pad directly beneath the oral hygiene instrument on the base.
